(19) United States
(12) Patent Application Publication
(10) Pub. No.: US 2008/0271092 A1
(43) Pub. Date: Oct. 30, 2008

(54) Methods and apparatus for controlling a satellite antenna

(75) Inventors: Martin A. Kits van Heyningen, Newport, RI (US); Robert J. Balog, Wrentham, MA (US); Richard F. Driscoll, Portsmouth, RI (US)

Correspondence Address: WOLF GREENFIELD & SACKS, P.C., 600 ATLANTIC AVENUE, BOSTON, MA, 02210-2206, US

(73) Assignee: KVH Industries, Inc., Middletown, RI (US)

(21) Appl. No.: 11/789,659

(22) Filed: Apr. 25, 2007

(51) Int. Cl. H04N 7/20

(52) U.S. Cl. 725/68

(57) ABSTRACT

Methods and apparatus are provided for issuing instructions to a satellite antenna configured to receive a transmission from any of a group of satellites and to provide a signal to a receiver. In accordance with one embodiment, the receiver is queried (e.g., by a control module, which in one embodiment is a device equipped with a microprocessor and memory storing instructions defining the query) to determine information relating to a channel selected by a user. Based on the information, a determination is made whether the antenna should receive a transmission from a satellite other than a currently selected satellite. If so, the antenna is instructed (e.g., by the control module) to locate the other satellite. In another embodiment, methods and apparatus are provided for use in systems having multiple receivers, including one master receiver coupled to the antenna and one or more other slave receivers which do not issue instructions to the antenna. In accordance with this embodiment, a determination is made whether a user of a slave receiver has selected a channel provided by a transmission from a satellite other than a currently selected satellite, and if so, the antenna is caused (e.g., by a control module coupled to the slave receiver) to locate the other satellite.

### FIELD OF THE INVENTION

This invention relates generally to providing instructions to a satellite antenna to search for and locate a particular satellite.

### BACKGROUND OF THE INVENTION

Conventional satellite communication systems include a receiving antenna (e.g., a parabolic dish antenna) connected to an arm supporting one or more feed horns, each of which collects signals at the focus of the antenna and channel the signals to a low noise block converter (LNB). The LNB amplifies the signals and converts them from microwaves to lower frequency signals which are sent along a cable to a receiver. The receiver includes a decoder which unscrambles audio and video signals protected by encryption and converts the signals to a form usable by, for example, a conventional television or other device (e.g., a computer). In general, an antenna may be mounted on a support structure which may be fixed to the ground, a building, or a mobile vehicle, such as a motor home, yacht or airplane.

Conventional satellite locator systems employ direction adjustment mechanisms to position the antenna so that it is pointed toward one or more selected satellites. In general, adjustments to the antenna's position depend on the antenna's location with respect to the selected satellite(s), which are in geosynchronous orbit in the Clarke Belt above the equator. More particularly, each satellite is located in a particular orbital slot within the Clarke Belt, the orbital slot being roughly defined by its longitudinal position. For example, a satellite in the 101 orbital slot is located at roughly 0 degrees latitude and 101 degrees west longitude. Typically, the antenna is positioned to point toward a particular satellite, although some antennas may be positioned to point toward a location from which transmissions may be received from multiple satellites (e.g., a line or plane roughly connecting the positions of the satellites). If the antenna is mounted on a mobile vehicle (or moved from one location to another), its position must generally be adjusted to continue receiving a transmission from a particular satellite.

An antenna may be constructed in any of various ways. For example, some early dish antennas had a single LNB and were designed to be directed toward a particular orbital slot at which a single satellite was located. Later antennas included two LNBs, and were designed to be able to receive a transmission from either or both of two satellites at any time. Specifically, these antennas were usually designed to be directed toward a line from which a transmission from both satellites could be received, and based on instructions provided by the receiver, a signal received by one of the LNBs was provided to the receiver. For example, some two-LNB antennas were designed to receive a transmission from satellites located at the 101 and 119 orbital slots.

Instructions provided by a receiver to an antenna having two LNBs generally take the form of a 22 kHz tone which the receiver transmits along a cable (e.g., a radio frequency (RF), or coaxial, cable) to the antenna. Conventionally, when the antenna observes a tone on the cable, it provides a signal received by a first LNB on the antenna to the receiver, and if the antenna observes no tone, a signal received by a second LNB on the antenna is provided to the receiver.

Some antennas are now equipped with more than two LNBs, since some satellite providers have found that two satellites do not provide sufficient bandwidth to support the various signals they wish to make available to customers. Of course, using a binary (i.e., on/off) tone to select from among more than two LNBs is not feasible. Specifically, a first LNB dedicated to a first satellite might be selected by the presence of the tone, and a second LNB dedicated to a second satellite might be selected by the absence of the tone, but any additional LNBs can not be effectively selected using only the tone.

Various solutions to this problem have arisen. One solution, used in a system in which an antenna may receive a transmission from any of three satellites, has been to shift the frequency(ies) of signals received from one of the satellites (e.g., the third satellite) and add these shifted frequency(ies) to a signal received from another of the satellites (e.g., the second satellite). In this arrangement, when the receiver requests a signal provided by the third satellite, it receives the signal provided by the third satellite, albeit at shifted frequencies, via the LNB dedicated to the second satellite.

Another solution, adopted mainly by providers of antennas having a single LNB, has been to enable the user to “pair” certain satellites using a selector (e.g., a switch on the receiver). In this respect, it should be appreciated that when an antenna is equipped with only a single LNB and is designed to receive a signal from more than one satellite, the antenna physically shifts to locate a selected satellite and receive a transmission.

In accordance with this solution, the user may be asked to pair a first satellite (e.g., located at the 101 orbital slot) with either a second satellite (e.g., located at the 119 orbital slot) or a third satellite (e.g., located at the 110 orbital slot). In this arrangement, when the user pairs the satellites at the 101 and 119 orbital slots together, and the antenna observes a tone on the cable, the antenna may shift to receive a transmission from the satellite at the 119 orbital slot, and if no tone is observed, then the antenna may shift to receive a transmission from the satellite at the 101 orbital slot (or vice versa). When the user pairs the satellites at the 101 and 110 orbital slots, and the antenna observes a tone on the cable, the antenna may shift to receive a transmission from the satellite at the 110 orbital slot, and if no tone is observed, the antenna may shift to receive a transmission from the satellite at the 101 orbital slot (or vice versa).

These two conventional solutions may be employed in combination. For example, when a selector is employed to pair certain satellites together, the transmission from one of the satellites may still require shifting so that a signal may be provided to the receiver at the frequency that it expects. As a result, if a signal received from a satellite located at the 110 orbital slot requires shifting for it to arrive at the receiver at the frequency that the receiver expects, then using a selector to pair the satellites located at the 101 and 110 orbital slots may cause a selective frequency shifter to be turned on when the antenna is instructed to receive a signal from the satellite at the 110 orbital slot.

### BRIEF SUMMARY OF THE INVENTION

One embodiment of the invention provides a method for use in a system comprising a receiver coupled to an antenna configured to receive a transmission from any of a group of satellites, the antenna being adapted to provide a signal to the receiver based on a transmission from one of the group of satellites, the receiver being adapted to allow a user to select a channel, the antenna receiving a transmission from a first satellite at a first time. The method, performed at a second time subsequent to the first time, comprises acts of: (A) causing the receiver to provide information relating to a channel selected by the user; (B) processing the information to determine whether the antenna should receive a transmission from a second satellite other than the first satellite; and (C) if it is determined in the act (B) that the antenna should receive a transmission from the second satellite, causing the antenna to search for the second satellite.

Another embodiment of the invention provides at least one computer-readable medium having instructions recorded thereon which, when executed in a system comprising a receiver coupled to an antenna configured to receive a transmission from any of a group of satellites, the antenna being adapted to provide a signal to the receiver based on a transmission from one of the group of satellites, the receiver being adapted to allow a user to select a channel, the antenna receiving a transmission from a first satellite at a first time, perform a method. The method, performed at a second time subsequent to the first time, comprises acts of: (A) causing the receiver to provide information relating to a channel selected by the user; (B) processing the information to determine whether the antenna should receive a transmission from a second satellite other than the first satellite; and (C) if it is determined in the act (B) that the antenna should receive a transmission from the second satellite, causing the antenna to search for the second satellite.

Yet another embodiment provides an apparatus for use in a system comprising a receiver coupled to an antenna configured to receive a transmission from any of a group of satellites, the antenna being adapted to provide a signal to the receiver based on a transmission from one of the group of satellites, the receiver being adapted to allow a user to select a channel, the antenna receiving a transmission from a first satellite at a first time. The apparatus comprises: a receiver selection controller operable to cause the receiver to provide information relating to a channel selected by the user at a second time subsequent to the first time; a satellite selection controller operable to process the information to determine whether the antenna should receive a transmission from a second satellite other than the first satellite; and a satellite search controller operable to, if it is determined by the satellite selection controller that the antenna should receive a transmission from the second satellite, causing the antenna to search for the second satellite.

Yet another embodiment provides a method for use in a system comprising a plurality of receivers, a plurality of control modules each coupled to a respective one of the receivers, an antenna configured to receive a transmission from any of a group of satellites and to provide a signal to at least one of the receivers based on a transmission from one of the group of satellites, the plurality of receivers comprising a master receiver coupled to the antenna and configured to instruct the antenna to locate a satellite and at least one slave receiver which is not configured to instruct the antenna to locate a satellite, each of the plurality of receivers being adapted to allow a user to select a channel, the antenna receiving a transmission from a first satellite at a first time. The method, performed at a second time subsequent to the first time, comprises acts of: (A) determining whether a user of a first slave receiver has selected a channel provided by a transmission from a second satellite different than the first satellite; (B) if it is determined in the act (A) that the user of the first slave receiver has selected a channel provided by a transmission from a second satellite different than the first satellite, causing, by a first control module coupled to the first slave receiver, the antenna to locate the second satellite.

Yet another embodiment provides at least one computer readable medium encoded with instructions which, when executed in a system comprising a plurality of receivers, a plurality of control modules each coupled to a respective one of the receivers, an antenna configured to receive a transmission from any of a group of satellites and to provide a signal to at least one of the receivers based on a transmission from one of the group of satellites, the plurality of receivers comprising a master receiver coupled to the antenna and configured to instruct the antenna to locate a satellite and at least one slave receiver which is not configured to instruct the antenna to locate a satellite, each of the plurality of receivers being adapted to allow a user to select a channel, the antenna receiving a transmission from a first satellite at a first time, performs a method at a second time subsequent to the first time. The method comprises acts of: (A) determining whether a user of a first slave receiver has selected a channel provided by a transmission from a second satellite different than the first satellite; (B) if it is determined in the act (A) that the user of the first slave receiver has selected a channel provided by a transmission from a second satellite different than the first satellite, causing, by a first control module coupled to the first slave receiver, the antenna to locate the second satellite.

### BRIEF DESCRIPTION OF THE DRAWINGS

FIG. 1 is a block diagram depicting a satellite locator system implemented in accordance with one embodiment of the invention;

FIG. 2 is a block diagram depicting a control module for a satellite locator system, implemented in accordance with one embodiment of the invention;

FIG. 3 is a flowchart depicting one example of a process performed in accordance with one embodiment of the invention;

FIG. 4 is a block diagram depicting a multi-receiver satellite locator system implemented in accordance with one embodiment of the invention.

### DETAILED DESCRIPTION OF THE INVENTION

Applicants have appreciated that the conventional arrangements described above wherein a binary tone and/or satellite pair selector are employed are less than ideal. For example, in an arrangement wherein an antenna is equipped with a single LNB and receives a transmission from more than two satellites, unless a satellite pair selector is employed, a receiver is unable to effectively instruct the antenna to receive a transmission from all three of the satellites, as a binary tone is ineffective in this regard. Specifically, the antenna might be instructed to point toward a first satellite by the presence of the tone, and to point toward a second satellite by the absence of the tone, but can not be effectively instructed to point toward any additional satellite using only the tone. Moreover, even if the satellite could be effectively instructed to point toward an additional satellite, the signal provided by that satellite might require shifting in order for it to arrive at the receiver at the frequency which the receiver expects, and employing only a binary tone only would be ineffective in designating which signals required shifting. As a result, a signal might not reach the receiver in the expected frequency range, and may not be processed properly.

However, Applicants have also appreciated that employing a satellite pair selector is also less than ideal because it inconveniences the user. For example, a user watching television who wishes to change to a channel supported by a transmission from a satellite not currently selected must travel to the receiver and select a different satellite pair to change the channel. This is inconvenient.

Moreover, in some settings, multiple receivers may be installed, and only one of the receivers may be capable of instructing the antenna to locate another satellite. For example, in some mobile vehicle installations (e.g., on some yachts and mobile homes), one of the receivers is coupled to the antenna and is designated as the master receiver, and all other receivers are designated as slave receivers and are incapable of instructing the antenna to locate another satellite. In these settings, if the user is watching a television coupled to a slave receiver and wishes to change to a channel supported by a transmission from a different satellite than that which is currently selected, the user must travel to the master receiver (which could be a considerable distance away), select the correct satellite pair, and then travel back to the original location to watch television. This also is inconvenient.

Accordingly, embodiments of the present invention provide methods and apparatus for providing instructions to an antenna to reposition to receive a transmission from a particular satellite without the use of a tone and/or a satellite pair selector. In one exemplary embodiment, a control module is coupled to a receiver and is configured to issue queries to the receiver, process information received from the receiver in response to the queries, and based on the results of the processing, issue one or more instructions to an antenna to locate a particular satellite. For example, in one embodiment, the control module may be adapted to poll the receiver at selected intervals (e.g., every 0.5 seconds) to determine the channel that the user has selected and the satellite from which the channel signal is to be received. The control module receives and processes this information from the receiver, determines whether the selected channel and/or satellite has changed since the last time the receiver was polled, and if a new satellite's transmission is to be received, issues an instruction to the antenna to locate the newly selected satellite. If the newly selected satellite is one which provides a signal that requires a frequency shift for the receiver to process the signal properly, the control module may initiate a signal frequency shift (e.g., by sending an instruction to a frequency shifter) so that the receiver receives the signal at the frequency it expects.

A control module implemented in accordance with embodiments of the invention may be employed, for example, to issue instructions to an antenna equipped with a single LNB and designed to receive a transmission from three or more satellites. However, the invention is not limited to such an implementation, as embodiments of the invention may be employed with any antenna having any number of LNBs and designed to receive a transmission from any number of satellites. The invention thus is not limited in this respect.

In one embodiment, a control module implemented in accordance with embodiments of the invention is a hardware device equipped with a microprocessor, memory and power source. The microprocessor executes instructions stored in memory and issues one or more queries to a receiver (e.g., via a Universal Serial Bus (USB) cable connected to the receiver's data port), processes information provided by the receiver in response to the queries, and issues commands to an antenna to locate a particular satellite as a result. If the control module is implemented as a hardware device, any suitably equipped processor and/or memory may be employed, as the invention is not limited in this respect. It should be appreciated, however, that a control module is not limited to being implemented via hardware, either wholly or in part. Embodiments of the invention may be implemented via software, firmware, hardware, or a combination thereof. For example, one embodiment of the invention may be implemented as software which is designed to be executed on a processor within a receiver, or on any other suitable device. The invention is not limited to any particular implementation.

In one embodiment, a control module implemented in accordance with embodiments of the invention issues one or more queries to a receiver using a command set which the receiver is configured to recognize (e.g., is specified by a maker of the receiver). For example, DirecTV® and Dish Network® receivers each recognize commands conforming to a particular command set, and are configured to execute those commands to provide various information relating to the receiver. In one embodiment, the control module is configured to issue a query to the receiver via its data port to request its “primary status,” which causes the receiver to respond with an indication of the channel and satellite currently selected, as well as other information.

Of course, the invention is not limited to such an implementation, as any suitable command, command set or form of instruction may be employed, to gather any suitable information. For example, command sets implemented by DirecTV® or Dish Network® receivers need not be employed, as any suitable command set may be used. Regardless of the command set employed, embodiments of the invention need not query the receiver to determine its primary status, as any information from which the channel and/or satellite may be derived may be requested. In addition, a control module implemented in accordance with embodiments of the invention need not query the receiver directly, as information may be requested from any source (e.g., a peripheral coupled to the receiver) which includes or has access to desired information. The invention is not limited to any particular implementation.

Based on information received from the receiver, the control module issues instructions to position the antenna. It should be appreciated that, although reference is made herein to providing instructions “to the antenna,” this phrase is employed for the reader's convenience, and that instructions (or commands, statements, etc., which may take any suitable form) may be provided to any suitable device, mechanism or other component which, when executed, causes the antenna to receive a transmission from one or more satellites. For example, in one embodiment, instructions may be issued to a support structure to reposition the antenna to receive a transmission from a particular satellite. However, the invention is not limited in this respect, as instructions may be provided to an antenna or to any module, device, mechanism or component in communication therewith.

Instructions may take any suitable form. For example, in one embodiment, the control module may issue a command (e.g., a serial command, Digital Satellite Equipment Control (DiSEqC) command, or any other suitable command) to instruct the antenna to locate a particular satellite.

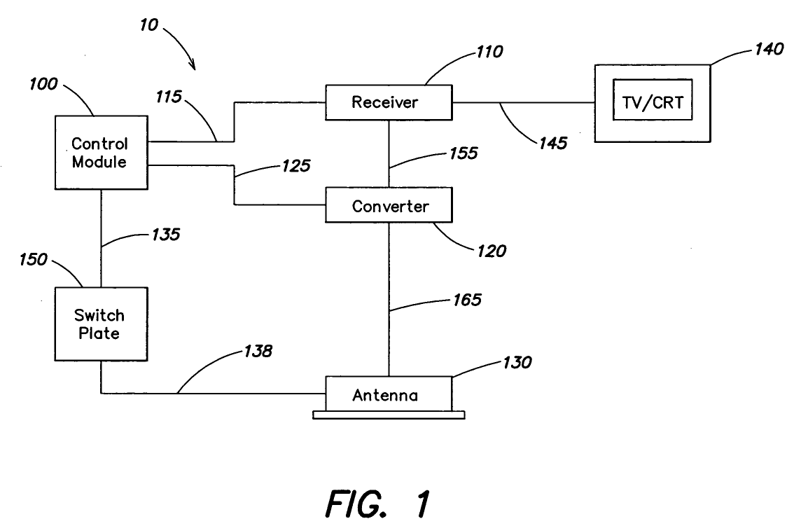

FIG. 1 depicts one example of a system implemented in accordance with embodiments of the invention. System 10 includes control module 100, which issues queries (e.g., using the DirecTV® or Dish Network® command set) to and receives responses from receiver 110 via link 115 (e.g., a USB cable connected to each of control module 100 and receiver 110 via respective USB ports). Control module 100 processes information provided by receiver 110 and issues commands (e.g., serial commands) to antenna 130 via link 135, switch plate 150 and link 138. Control module 100 is also coupled to converter 120 via link 125 (e.g., an RF cable). Converter 120 may serve any of numerous functions, such as shifting the frequency of the signal received from antenna 130, and provides the signal via link 155 to receiver 110. Receiver 110 decodes the signal received from converter 120, and produces an output signal, which is delivered to TV/CRT 140 via link 145.

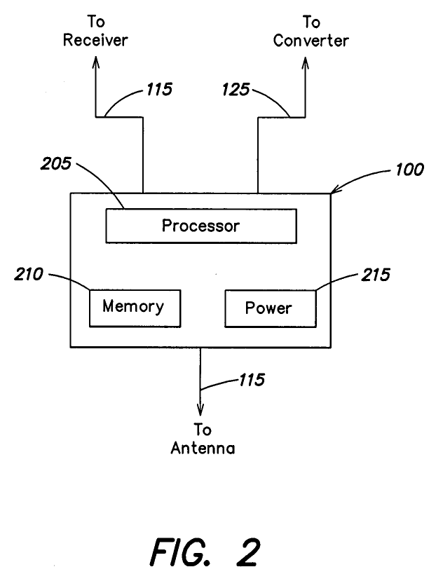

FIG. 2 depicts one exemplary implementation of control module 100 in further detail. Specifically, FIG. 2 depicts an embodiment wherein control module 100 is implemented via hardware and software. In particular, control module 100 includes memory 210, on which various information used to manage the functions of control module 100 is stored. For example, memory 210 may store programmed instructions for execution on processor 205. For example, these programmed instructions may define one or more queries for transmission to receiver 110, such that when the instructions are executed on processor 205, control module 100 issues the query(ies) to receiver 110. The query(ies) may, for example, conform to the DirecTV® or Dish Network® command set, although the invention is not limited to such an implementation, as any suitable command(s) may be employed.

Memory 210 may also store programmed instructions designed to be executed on processor 205 to process information provided by receiver 110 in response to the query(ies), and may be configured to store this information and the results of the processing by processor 205.

Memory 210 may further store programmed instructions defining one or more commands for transmission to antenna 130, such that when these programmed instructions are executed on processor 205, control module 1000 issues the command(s) to antenna 130 to cause antenna 130 to be directed toward a particular satellite.

It should be appreciated that although FIG. 2 depicts only a single memory 210, processor 205 and power source 205, any suitable number of any of these components may be employed, as the invention is not limited in this respect.

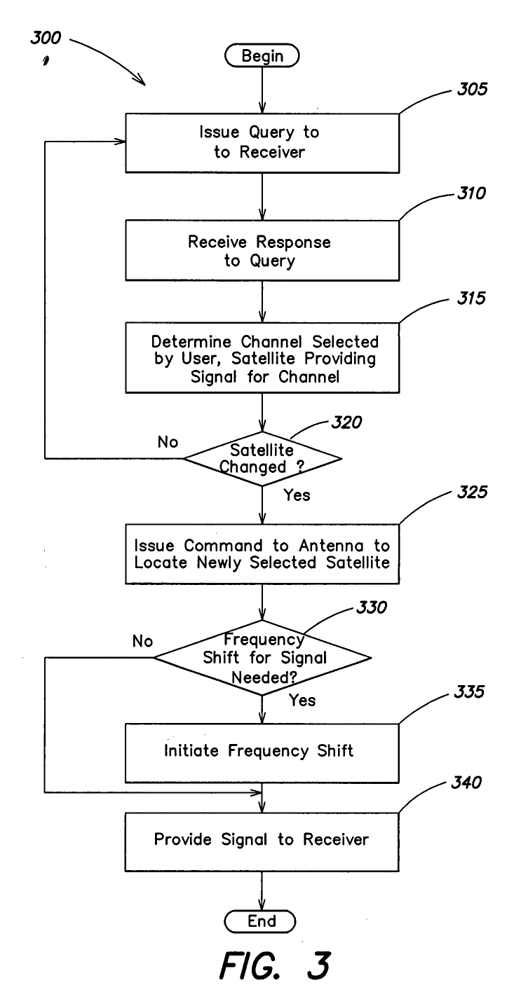

FIG. 3 depicts one example of a process 300 which may be performed in accordance with embodiments of the invention. In particular, control module 100 (and/or any other components, such as those depicted in FIG. 1) may perform process 300 to formulate and issue one or more queries to a receiver 110, receive information provided by receiver 110 in response to the query(ies), and issue instructions to an antenna based on the information.

At the start of process 300, one or more queries is issued to receiver 110 in act 305. For example, control module 100 may execute (e.g., by processor 205) programmed instructions stored in memory 210 to issue one or more queries to receiver 110. Process 300 then proceeds to act 310, wherein a response to the query is received from receiver 110 (e.g., by control module 100 via link 115, FIG. 1).

The process then proceeds to act 315, wherein a channel selected by a user of the receiver and a satellite providing a transmission for the selected channel is identified. For example, control module 100 may process information provided by receiver 110 in act 310 to determine the channel and satellite (e.g., by executing programmed instructions stored in memory 210 on processor 205), and/or this information may be provided by receiver 110 to control module 100 in act 310.

It should be appreciated that, in many conventional satellite locator system implementations, determining the channel that the user has selected via the receiver does not reliably indicate the satellite to which the antenna should be directed. For example, some satellite providers may move channels between satellites, such that any channel may be transmitted from any satellite at any time. These providers may employ a guide table to indicate the satellite from which a particular signal may be received at any time. The guide table is typically loaded to the receiver when the receiver starts up, and may be updated and/or refreshed over time. The guide table may define, for example, that to receive a signal for channel 3, the antenna: must be directed to a satellite located at orbital slot 101. Thus, in some embodiments, information from the guide table may be provided to control module 100 in act 310 in response to the query(ies) issued in act 305.

In act 320, a determination is made whether the channel and/or satellite determined in act 315 have changed. This determination may be made in any of numerous ways, as the invention is not limited in this respect. For example, as described above, control module 100 may be configured to poll receiver 110 at predetermined intervals (in one embodiment, every 0.5 seconds), and may store (e.g., in memory 210) an indication of the results of a previous determination of the channel and satellite. Thus, act 320 may involve a comparison between the results of act 315 and the results of a previous determination stored in memory. Of course, the invention is not limited to such an implementation. For example, information provided by receiver 110 in act 310 may include an indication that the channel and/or satellite has changed, a change may be identified by comparing the results of the determination in act 315 against information stored in receiver 110, or any other suitable technique may be employed. The invention is not limited to performing this determination in any particular manner.

If it is determined in act 320 that the channel and/or satellite have not changed, then the process returns to act 305, wherein a query is issued to receiver 110 (e.g., after a predetermined interval). However, if it is determined in act 320 that the channel and/or satellite have changed, then the process proceeds to act 325, wherein a command is issued to the antenna to locate the newly selected satellite. This command may be issued in any suitable fashion. For example, in one embodiment, control module 100 issues a serial command to antenna 130, although the invention is not limited to such an implementation.

The process then proceeds to act 330, wherein a determination is made whether a frequency shift is needed for a transmission for the selected channel and satellite. For example, control module 100 may execute programmed instructions (e.g., stored in memory 210, FIG. 2) which define that if a selected satellite is one which provides signals that require frequency shifting, then a frequency may be initiated so that the signal is provided to receiver 110 at the frequency it expects. If a frequency shift is needed, the process proceeds to act 335, wherein a frequency shift is initiated. For example, control module 100 may issue one or more instructions to a selective frequency shifter, such as one which is coupled to or integrated with receiver 110. In other embodiments, control module 110 may perform the frequency shift, such as by executing instructions which instruct one or more integrated components to do so. Upon the completion of act 335, or if it is determined in act 330 that a frequency shift is not needed, the process proceeds to act 340, wherein a signal is provided to receiver 110. Process 300 then completes.

In some embodiments, control module 100 is configured to provide functionality which may be useful in some multi-receiver implementations. In this respect, as described above, in some conventional multi-receiver implementations, one receiver is designated as a master receiver and is capable of issuing instructions to the antenna, and all other receivers are designated as slave receivers and are not capable of issuing instructions to the antenna. Thus, in these conventional implementations, the master receiver coupled to the antenna effectively selects the satellite from which all slave receivers receive a transmission. As a result, while certain slave receivers may be tuned to different channels than that to which the master receiver is tuned, no slave receiver may select a channel which is not provided by the satellite selected by the master receiver. Consequently, if a user of a slave receiver wants to select a channel which is not supported by the satellite currently selected by the master receiver, the user must travel to the master receiver (which can be a considerable distance away), change the channel or select the desired satellite via the master receiver, and then travel back to the original location to watch the desired channel. This is inconvenient.

One conventional approach to this issue is to employ an RF remote control that is separate from the remote control used to control the receiver. The user may, for example, use the RF remote control to issue commands to the master receiver and thus to the antenna. This is less than ideal as well, as it requires that the user purchase and maintain two separate remote controls for the same system.

Accordingly, one embodiment of the invention provides methods and apparatus whereby one or more control modules coupled to respective slave receivers are connected (e.g., via a serial communication link) to a control module coupled to a master receiver. A control module coupled to a slave receiver may issue commands to the control module coupled to the master receiver rather than to the antenna, and the control module coupled to the master receiver may pass those commands along to the antenna. As a result, a user of any receiver may control the antenna's direction and the satellite from which a transmission is received. In such an arrangement, a receiver no longer performs as a “master” or “slave”.

In one embodiment, a control module may issue one or more queries to a “slave” receiver to which it is coupled, to determine the channel and satellite the user has selected, such as in the manner described above with reference to FIGS. 1-3. If a new satellite should be selected, the control module coupled to this receiver issues a command to a control module coupled to the “master” receiver. The control module coupled to this receiver may pass along these instructions to the antenna. As a result, the antenna may be shifted toward a particular satellite selected by the user of any receiver.

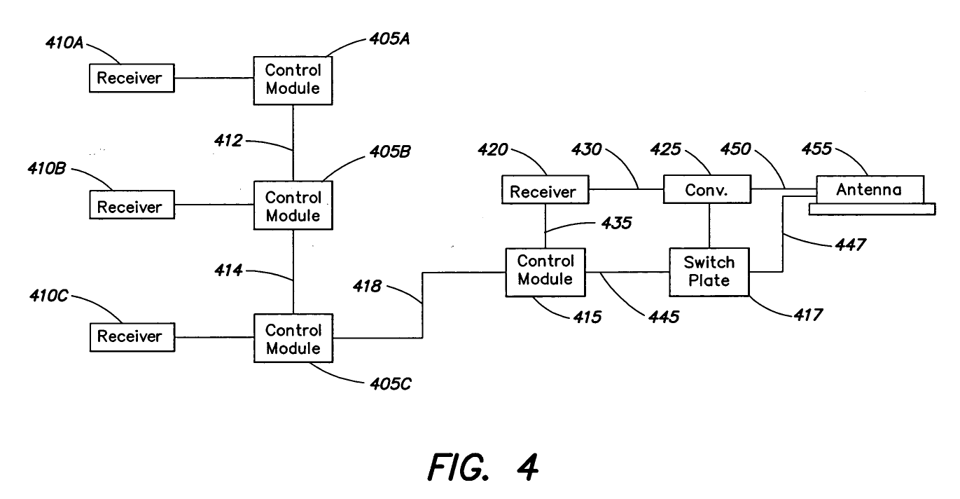

FIG. 4 depicts one example of a multi-receiver implementation wherein multiple control modules, each coupled to a respective receiver, are connected in a “daisy chain” arrangement. Specifically, system 400 includes receivers 410A-410C, each coupled to a respective control module 405A-405C. Each of control modules 405A-405C issues queries to a respective receiver 410A-410C, and receives information from the receiver, such as in a manner described above.

Control module 405C is connected to control module 415 (e.g., via a serial communications link). Control module 415 is coupled to receiver 420, and to antenna 455 via switch plate 417. Receiver 420 is also coupled to converter 425. Control module 415 issues queries to, and receives information from, master receiver 420. Control module 415 issues commands to antenna 455.

When a user of one of receivers 410A-410C selects a channel which requires antenna 455 to receive a transmission from a new satellite, its respective control module 405 issues a command to control module 415, which in turn passes the command along to antenna 455. In the exemplary configuration shown, a control module 405 transmits the command “up the chain” to control module 415. If a control module coupled to a slave receiver receives the command, it continues to pass the command up the chain until the command receives control module 415.

For example, if a user of slave receiver 410A selects a channel which requires antenna 455 to receive a transmission from a different satellite than that which is currently selected, control module 405A issues a command via link 412 to control module 405B. Control module 405B receives the command and processes instructions (e.g., stored in memory 210, FIG. 2) which define that when a command is received from 405A, the command should be transmitted by control module 405B via link 414 to control module 405C. Control module 405C may execute similar instructions which define that when a command is received from 405B, the command should be transmitted by control module 405C via link 418 to control module 415. Control module 415 may execute similar instructions which define that when a command is received from control module 405C, the command should be transmitted via switch plate 417 to antenna 455. Antenna 455 may then process the command, and shift to receive a transmission from a different satellite than that to which it is currently directed.

It should be appreciated that system 400 is merely exemplary, and that numerous variations are possible. For example, any number of receivers may be employed, as the invention is not limited in this respect. In addition, control modules need not be connected in a daisy chain arrangement or transmit information via a serial communications link (e.g., they may communicate via RF signals). Any suitable communications infrastructure and/or protocol may be employed, as the invention is not limited to any particular implementation.

The above-described embodiments of the present invention can be implemented in any of numerous ways. For example, the above-discussed functionality can be implemented using hardware, software or a combination thereof. When implemented in software, the software code can be executed on any suitable processor or collection of processors, whether provided in a single computer or distributed among multiple computers. It should further be appreciated that any component or collection of components that perform the functions described above can be generically considered as one or more controllers that control the above-discussed functions. The one or more controllers can be implemented in numerous ways, such as with dedicated hardware, or by employing one or more processors that are programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer system resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Embodiments of the invention, when implemented via software, may be written using any of a number of suitable programming languages and/or conventional programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. Computer-executable instructions may; be in many forms, such as program modules, executed by one or more computers or other devices. Generally, program modules include routines, programs, objects, components, data structures, etc. that perform particular tasks or implement particular abstract data types.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

While the invention has been particularly shown and described with reference to specific embodiments, these embodiments are presented by way of example only, as it is not practical to enumerate all potential implementations. It should be understood by those skilled in the art that various changes in form and detail may be made therein without departing from the spirit and scope of the invention, which is defined in the following claims.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. In a system comprising a receiver coupled to an antenna configured to receive a transmission from any of a group of satellites, the antenna being adapted to provide a signal to the receiver, the receiver being adapted to allow a user to select a channel, the antenna receiving a transmission from a first satellite at a first time, a method, performed at a second time subsequent to the first time, comprising acts of:
(A) causing the receiver to provide information relating to a channel selected by the user;
(B) processing the information to determine whether the antenna should receive a transmission from a second satellite; and
(C) if it is determined in the act (B) that the antenna should receive a transmission from the second satellite, causing the antenna to search for the second satellite.

2. The method of claim 1, wherein the act (A) comprises issuing a query to the receiver which complies with a command set implemented by a DirecTV® or Dish Network® receiver.

3. The method of claim 1, wherein the acts (A)-(C) are performed by a control module which is implemented via hardware and software.

4. The method of claim 1, wherein the acts (A)-(C) are performed by a control module implemented via software.

5. The method of claim 1, wherein the group of satellites comprises at least three satellites.

6. The method of claim 1, wherein the antenna comprises a single low noise block converter (LNB).

7. The method of claim 1, wherein the acts (A) and (B) are repeated at a predetermined interval.

8. The method of claim 1, further comprising acts of:
(D) determining whether a signal based on a transmission received from the second satellite requires a frequency shift; and
(E) if it is determined in the act (D) that the signal based on the transmission received from the second satellite requires a frequency shift, causing the frequency of at least a portion of the signal to be shifted before the signal is provided to the receiver.

9. The method of claim 8, wherein the act (E) further comprises issuing an instruction to a selective frequency shifter.

10. The method of claim 1, wherein the act (C) further comprises issuing a serial command to the antenna to point the antenna toward an orbital slot occupied by the second satellite.

11. At least one computer-readable medium having instructions recorded thereon which, when executed in a system comprising a receiver coupled to an antenna configured to receive a transmission from any of a group of satellites, the antenna being adapted to provide a signal to the receiver, the receiver being adapted to allow a user to select a channel, the antenna receiving a transmission from a first satellite at a first time, perform a method, at a second time subsequent to the first time, comprising acts of:
(A) causing the receiver to provide information relating to a channel selected by the user;
(B) processing the information to determine whether the antenna should receive a transmission from a second satellite; and
(C) if it is determined in the act (B) that the antenna should receive a transmission from the second satellite, causing the antenna to search for the second satellite.

12. The at least one computer-readable medium of claim 11, wherein the act (A) comprises issuing a query to the receiver which complies with a command set implemented by a DirecTV® or Dish Network® receiver.

13. The at least one computer-readable medium of claim 11, wherein the acts (A)-(C) are performed by a control module which is implemented via hardware and software.

14. The at least one computer-readable medium of claim 11, wherein the acts (A)-(C) are performed by a control module implemented via software.

15. The at least one computer-readable medium of claim 11, wherein the group of satellites comprises at least three satellites.

16. The at least one computer-readable medium of claim 11, wherein the antenna comprises a single low noise block converter (LNB).

17. The at least one computer-readable medium of claim 11, wherein the acts (A) and (B) are repeated at a predetermined interval.

18. The at least one computer-readable medium of claim 11, further comprising acts of:
(D) determining whether a signal based on a transmission received from the second satellite requires a frequency shift; and
(E) if it is determined in the act (D) that the signal based on the transmission received from the second satellite requires a frequency shift, causing t he frequency of at least a portion of the signal to be shifted before the signal is provided to the receiver.

19. The at least one computer-readable medium of claim 18, wherein the act (E) further comprises issuing an instruction to a selective frequency shifter.

20. The at least one computer-readable medium of claim 11, wherein the act (C) further comprises issuing a serial command to the antenna to point the antenna toward an orbital slot occupied by the second satellite.

21. An apparatus for use in a system comprising a receiver coupled to an antenna configured to receive a transmission from any of a group of satellites, the antenna being adapted to provide a signal to the receiver, the receiver being adapted to allow a user to select a channel, the antenna receiving a transmission from a first satellite at a first time, the apparatus comprising:
a receiver selection controller operable to cause the receiver to provide information relating to a channel selected by the user at a second time subsequent to the first time;
a satellite selection controller operable to process the information to determine whether the antenna should receive a transmission from a second satellite; and
a satellite search controller operable to, if it is determined by the satellite selection controller that the antenna should receive a transmission from the second satellite, causing the antenna to search for the second satellite.

22. The apparatus of claim 21, wherein the receiver selection controller is further operable to issue a query to the receiver which complies with a command set implemented by a DirecTV® or Dish Network® receiver.

23. The apparatus of claim 21, wherein the receiver selection controller, satellite selection controller and satellite search controller are implemented via hardware and software.

24. The apparatus of claim 21, wherein the receiver selection controller, satellite selection controller and satellite search controller are implemented via software.

25. The apparatus of claim 21, wherein the group of satellites comprises at least three satellites.

26. The apparatus of claim 21, wherein the antenna comprises a single low noise block converter (LNB).

27. The apparatus of claim 21, wherein the receiver selection controller and satellite selection controller are further operable to cause the receiver to provide information relating to the channel selected by the user and process the information to determine whether the antenna should receive a transmission from the second satellite at a predetermined interval.

28. The apparatus of claim 21, further comprising acts of:
a determination controller operable to determine whether a signal based on a transmission received from the second satellite requires a frequency shift; and
a shift controller operable to, if it is determined by the determination controller that the signal based on the transmission received from the second satellite requires a frequency shift, cause the frequency of at least a portion of the signal to be shifted before the signal is provided to the receiver.

29. The apparatus of claim 28, wherein the shift controller is further operable to issue an instruction to a selective frequency shifter.

30. The apparatus of claim 21, wherein the satellite search controller is further operable to issue a serial command to the antenna to point the antenna toward an orbital slot occupied by the second satellite.

31. In a system comprising a plurality of receivers, a plurality of control modules each coupled to a respective one of the receivers, an antenna configured to receive a transmission from any of a group of satellites and to provide a signal to at least one of the receivers, the plurality of receivers comprising a master receiver coupled to the antenna and configured to instruct the antenna to locate a satellite and at least one slave receiver, each of the plurality of receivers being adapted to allow a user to select a channel, the antenna receiving a transmission from a first satellite at a first time, a method, performed at a second time subsequent to the first time, comprising acts of:
(A) determining whether a user of a first slave receiver has selected a channel provided by a transmission from a second satellite different than the first satellite;
(B) if it is determined in the act (A) that the user of the first slave receiver has selected a channel provided by a transmission from a second satellite, causing, by a first control module coupled to the first slave receiver, the antenna to locate the second satellite.

32. The method of claim 21, wherein the act (A) comprises issuing, by the first control module to the first slave receiver, a query complying with a command set implemented by a DirecTV® or Dish Network® receiver.

33. The method of claim 21, wherein the act (B) further comprises transmitting, by the first control module to a master control module coupled to the master receiver, a command for the antenna to locate the second satellite.

34. The method of claim 23, wherein the act (B) further comprises transmitting the command via a serial communications link coupling the first control module and the master control module.

35. The method of claim 23, wherein the command is a serial command.

36. The method of claim 23, wherein the system further comprises at least two slave receivers including the first slave receiver and a second slave receiver, a second control module being coupled to the second slave receiver, to the first control module and to the master control module, and wherein the act (B) further comprises:
(B1) transmitting, by the first control module to the second control module, a command for the antenna to locate the second satellite; and
(B2) transmitting, by the second control module to the master control module, the command.

37. At least one computer readable medium encoded with instructions which, when executed in a system comprising a plurality of receivers, a plurality of control modules each coupled to a respective one of the receivers, an antenna configured to receive a transmission from any of a group of satellites and to provide a signal to at least one of the receivers, the plurality of receivers comprising a master receiver coupled to the antenna and configured to instruct the antenna to locate a satellite and at least one slave receiver, each of the plurality of receivers being adapted to allow a user to select a channel, the antenna receiving a transmission from a first satellite at a first time, perform a method, at a second time subsequent to the first time, comprising acts of:
(A) determining whether a user of a first slave receiver has selected a channel provided by a transmission from a second satellite different than the first satellite;
(B) if it is determined in the act (A) that the user of the first slave receiver has selected a channel provided by a transmission from a second satellite, causing, by a first control module coupled to the first slave receiver, the antenna to locate the second satellite.

38. The at least one computer readable medium of claim 21, wherein the act (A) comprises issuing, by the first control module to the first slave receiver, a query complying with a command set implemented by a DirecTV® or Dish Network® receiver.

39. The at least one computer readable medium of claim 21, wherein the act (B) further comprises transmitting, by the first control module to a master control module coupled to the master receiver, a command for the antenna to locate the second satellite.

40. The at least one computer readable medium of claim 23, wherein the act (B) further comprises transmitting the command via a serial communications link coupling the first control module and the master control module.

41. The at least one computer readable medium of claim 23, wherein the command is a serial command.

42. The at least one computer readable medium of claim 23, wherein the system further comprises at least two slave receivers including the first slave receiver and a second slave receiver, a second control module being coupled to the second slave receiver, to the first control module and to the master control module, and wherein the act (B) further comprises:
(B1) transmitting, by the first control module to the second control module, a command for the antenna to locate the second satellite; and
(B2) transmitting, by the second control module to the master control module, the command.
